(19) United States
(12) Patent Application Publication
(10) Pub. No.: US 2015/0078745 A1
(43) Pub. Date: Mar. 19, 2015

(54) SYSTEM AND METHOD FOR DESIGNING AND CONSTRUCTING OPTICAL NETWORKS

(71) Applicants: Kimon Papakos, Evanston, IL (US); Mark E. Boduch, Geneva, IL (US)

(72) Inventors: Kimon Papakos, Evanston, IL (US); Mark E. Boduch, Geneva, IL (US)

(21) Appl. No.: 14/029,891

(22) Filed: Sep. 18, 2013

(51) Int. Cl. H04L 12/24; G06Q 30/06; H04Q 11/00

(52) U.S. Cl. CPC H04L 41/12; H04Q 11/0062; H04L 41/0806; G06Q 30/0621; H04Q 2011/009
USPC 398/45

(57) ABSTRACT

A system and method for designing and constructing optical networks is provided. The system comprises: a server, and interactive software program residing on the server, an interactive input device—capable of accessing the interactive software program residing on the server, and a communication network—used to connect the interactive input device to the server. The method comprises: entering network topology information and service demands for a plurality of nodes into the interactive software program residing on the server, having the interactive software program determine the required optical equipment for the nodes, and ordering the required optical equipment for the nodes using the interactive software program.

### RELATED APPLICATION

None

### BACKGROUND

In the past it has been a difficult task to design and construct an optical network. This is partly due to the equipment used within the optical network, and partly due to the available tools and instructions used to design and construct optical networks. In the past, both the optical equipment, and the tools and instructions for designing and constructing optical networks were very complex.

### SUMMARY

A system and method for designing and constructing optical networks is presented. The method includes entering network topology information for a plurality of nodes into an interactive software program residing on a server. Following this, the method includes entering service demands for the nodes into the interactive software program residing on the server. For existing optical networks, the network topology information and service demands may be entered into the interactive software program residing on the server using human interfaces residing within the plurality of nodes making up the optical network. Once this information is entered, the interactive software program determines the optical equipment for the optical nodes within the optical network. The method then includes ordering optical equipment directly through the interactive software program residing on the server.

A system used to design and construct optical networks using optical equipment comprises, a server, an interactive software program residing on the server—allowing input of network topology information and service demands for a plurality of optical nodes, a communication network, and an interactive input device capable of accessing the interactive software program residing on the server. The interactive software program determines the required optical equipment for the plurality of optical nodes.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of an example embodiment of the present invention showing a system used to design and construct optical networks using optical equipment.

FIG. 2 is an illustration showing a graphical view of an optical network containing optical nodes and optical links in an example embodiment of the present invention.

FIG. 3 is another illustration showing a graphical view of an optical network containing optical nodes and optical links in an example embodiment of the present invention.

FIG. 4 shows a procedure for designing and constructing an optical network according to the present invention

### DETAILED DESCRIPTION

A description of example embodiments of the invention follows.

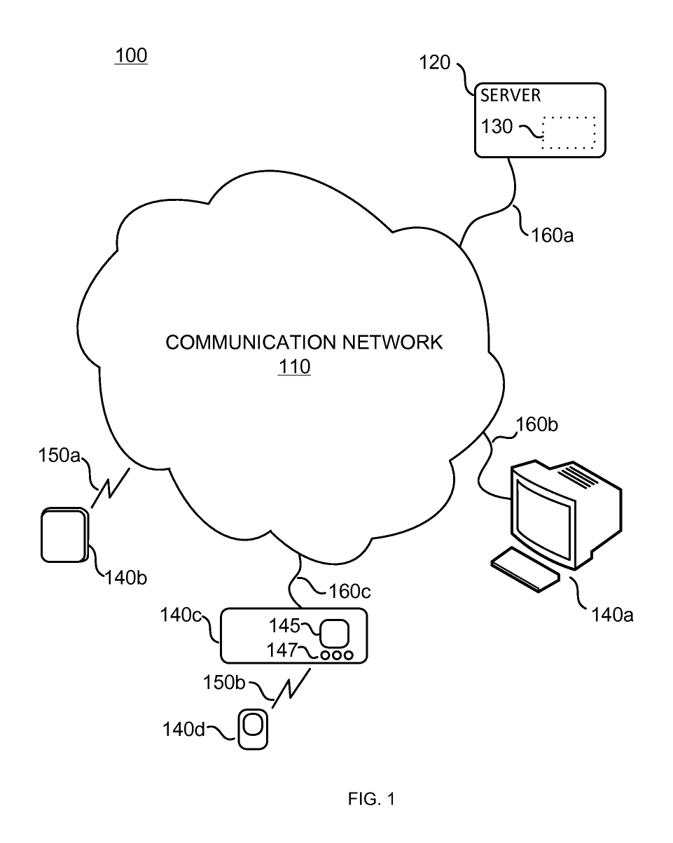

FIG. 1 is an illustration of a system 100 used to design and construct an optical network using optical equipment. It comprises a server 120, an interactive software program 130 residing on the server, a communication network 110, and an interactive input device 140a-d. The communication network 110 may be a private communication network, a public communication network (such as the internet), or a combination of a private communication network and public communication network. The communication network may be accessed via electrical cabling 160a-c, or wirelessly 150a-b. The interactive input device may be a computer device 140a directly connected (or wirelessly connected) to the communication network. Alternatively, the interactive input device may be a strictly wireless device, such as a smart phone or tablet device 140b. The optical equipment 140c of the optical network itself may also be used as an interactive input device. Such optical equipment may contain an integrated touch screen 145 and/or integrated buttons/keyboard 147. Lastly, the system may further include a controller 140d that wirelessly communicates 150b to the optical equipment 140c for the purpose of accessing the server 120 through the optical equipment 140c by way of the communication network 110.

At one extreme, the server may be a private server operated on a private communication network. At the other extreme, the server may be a public server that is accessed over the public internet (public cloud computing). For this later case, security software must be in place to prevent unauthorized users. Hybrid models lie between the two extreme server models. For instance, the server may be operated by a third party but may reside on a private network. Furthermore, in all cases, whenever the term server is used, it is implied that the server function may be implemented with multiple servers—running on multiple machines.

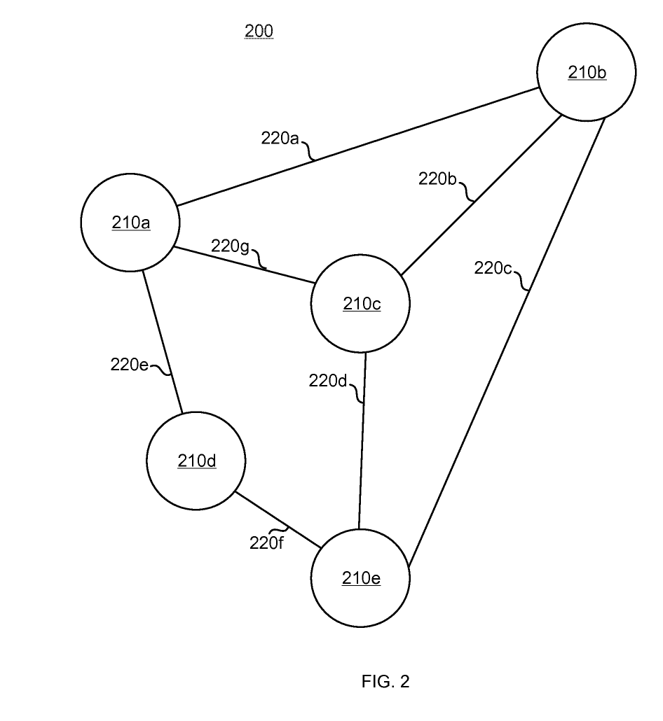

The interactive software program 130 residing on the server (hosted on the server) 120 allows a user to enter a design of an optical network. The optical network may be entered in a textual manner, a graphical manner, or a combination textual and graphical manner. The user of the system used to design and construct optical networks 100 may begin designing an optical network by first entering a plurality of optical nodes into the interactive software program. The user may then interconnect the entered nodes by entering connectivity links between the optical nodes. FIG. 2, illustrates a graphical representation of an optical network 200 containing both optical nodes 210a-e and connectivity links 220a-g.

When entering the optical network 200 into the interactive software program, the user may first place optical nodes 210a-e by choosing an “optical node icon” (for example), and then dragging the icon into an area of a display screen. The user may repeat this operation for any additional optical nodes of the optical network. The optical node icon may be contained within a separate area of the screen entitled “optical network elements” (for example). Alternatively, a pull-down menu may be used to first select the placement of an optical node, and then once the optical node is placed on the display screen, a graphical input device such as a mouse (or a finger, in the case of a touch screen) may be used to further position the placed optical node.

When entering the connectivity links between the optical nodes, the user may first select the placement of a connectivity link by choosing a “link icon” (for example) from a separate area of the screen entitled “optical network elements”, or the user may select the placement of a connectivity link from a pull-down menu. Once the link for placement is selected, the link may be graphically placed between two optical nodes using a graphical input device, or it may be placed between nodes in a textual manner by typing in the two end-points of the link.

The combination of optical nodes and connectivity links comprises the topology information of the optical network.

The resulting user entered optical network may comprise any number of optical nodes and connectivity links. An example optical network 200 is illustrated in FIG. 2. It contains optical nodes 210a, 210b, 210c, 210d, and 210e. It also contains connectivity links 220a—connecting optical nodes 210a and 210b, 220b—connecting optical nodes 210b and 210c, 220c—connecting optical nodes 210b and 210e, 220d—connecting optical nodes 210c and 210e, 220e—connecting optical nodes 210a and 210d, 220f—connecting optical nodes 210d and 210e, and 220g—connecting optical nodes 210a and 210c.

Each connectivity link may be physically implemented with a group of two optical fibers—one for each direction of information. The user may additionally enter fiber characterization information for the optical fibers of the connectivity links. Such information may comprise: fiber type, fiber chromatic dispersion (CD), fiber polarization mode dispersion (PMD), fiber insertion loss (IL), fiber chromatic dispersion slope, fiber length, and other fiber characteristics.

The user may additionally enter in the physical location of each optical node. This may typically be the mailing address of the building where each optical node will be located. Alternatively, the physical location may be described by the GPS (Global Positioning System) coordinates of the location of the building where each optical node will be located.

Once the optical network topology information has been entered into the interactive software program on the server, the user may enter the service demands of the optical network. Each service demand may minimally described with the following attributes: a “service type” attribute, a “service rate” attribute, a “service source” attribute, and one or more “service destination” attributes. Examples of service type attributes may include: SONET, SDH, Ethernet, OTN, fiber channel, and wavelength. Examples of service rate attributes may include: 622 Mbps (OC-12), 1 Gbps (GE) 2.5 Gbps (OC-48), 10 Gbps (OC-192 and 10GE), etc. Service source and destination attributes would typical be described in terms of the optical node locations.

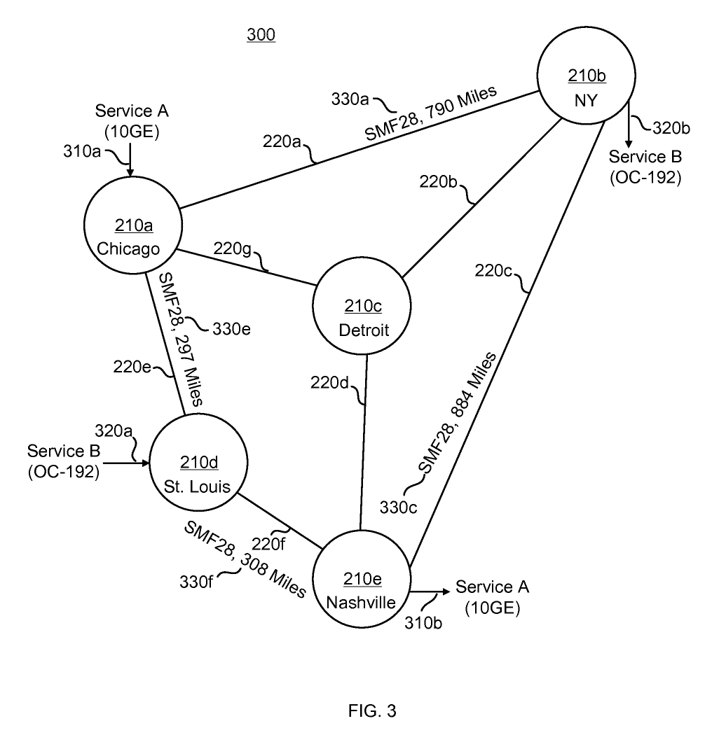

Once optical network topology information, node location information, fiber characteristics information, and service demands information is entered into the interactive software program on the server, the graphical representation of the optical network may be updated to include some aspects or all aspects of this information, such as shown in FIG. 3. In FIG. 3, the fiber type and length 330a have been shown for link 220a, the fiber type and length 330c have been shown for link 220c, the fiber type and length 330e have been shown for link 220e, and the fiber type and length 330f have been shown for link 220f. In addition, Service “A” 310a-b and Service “B” 320a-b are shown in the optical network graphical diagram 300 shown in FIG. 3.

Once the optical network topology information, service demands information, and fiber characterization information has been entered into the interactive software program on the server, the interactive software program determines the optical equipment required for the plurality of optical nodes within the designed optical network. This determination may be done automatically, or it may be done upon being explicitly told to do so by the user. For example, there may be a readily available “soft button” (also known as a “virtual button”) located on a graphical screen provided by the interactive software program that, when selected, generates a list of optical equipment needed to construct the designed optical network.

Once the list of optical equipment is generated, the list of equipment may be ordered through the interactive software program running on the server. For example, there may be a readily available “soft button” located on a graphical screen provided by the interactive software program that, when selected, places an order for the list of optical equipment needed to construct the designed optical network.

The optical equipment may then be pre-provisioned; so that once the equipment is installed it will immediately begin operation.

Since the physical location of each optical node is entered into the interactive software program residing on the server, the optical equipment needed for each optical node may be shipped directly to the location of each optical node. The interactive software program residing on the server automatically determines the shipping destination for the optical equipment such that each piece of optical equipment for a given optical node is shipped to the location of the given optical node. However, an “over-ride” option may be provided if there is a desire to send any or all of the equipment to a centralized location.

Once the optical equipment for a given node arrives at the location of the given node, installation of the equipment may begin. For a new node, simple written instructions included with the packaging of the optical equipment may indicate a “first piece of equipment to be installed”. The first piece of equipment to be installed may be a first enclosure containing a microprocessor capable of executing software instructions. Alternatively, the first piece of equipment to be installed may actually be two pieces of equipment such as an enclosure and separate processor card that may need to be inserted into the enclosure. Once the “first piece(s) of equipment to be installed” are installed, a bootstrapping software program will automatically execute. The bootstrapping software program may run some rudimentary checks on the available hardware, and then download the node specific executable software for the optical node from the server. Therefore, once the server is contacted by the bootstrapping software program within the optical node, the server initiates a download of executable software to the optical equipment installed within an optical node. Once the executable software is loaded onto the optical node, control of the optical node will pass to the newly loaded executable software.

Alternatively, the first piece of equipment to be installed may be preloaded with the executable software code required for the specific optical node in which it will be installed. For this case, the first piece of equipment to be installed may not contact the interactive software program on the server for executable software, or alternatively, it may contact the interactive software program on the server for any updates to its preloaded executable software code.

Once the optical node has its specific executable software, the node specific software is used to complete the installation of the optical equipment for the optical node. The optical node may use both visual and audio aids to complete the installation. For instance, the “first piece(s) of equipment to be installed” may include a visual screen with specific instructions (including perhaps figures, photos, and film clips) on how to complete the installation. Instructions may include attaching the optical fiber from other optical nodes, and then verifying the connectivity between the node being installed and the other nodes within the optical network.

The executable software operating within installed optical equipment within an optical node provides installation instructions for additional equipment within the optical node. For instance, a second enclosure may need to be installed and attached to a first enclosure. For this case, the executable software operating within installed optical equipment may provide visual and/or audio instructions on how to install the second enclosure.

As mentioned previously, the optical equipment itself may be used as an interactive input device. For existing optical nodes, the equipment within the node itself may be used to add new equipment into the optical node, and then purchase the new equipment for the node. For instance, when adding a new service demand to a particular node, the node may provide visual and/or audio feedback to the installer which indicates that an additional service card is required. The optical node may then provide the installer with the option of ordering the service card directly through the optical equipment itself Alternatively, the installer may use a controller that wirelessly interacts directly with the optical node in order to add a new service. For this case, the wireless controller may indicate that a new service card is required to complete the installation, and then may give the installer the option of ordering the needed service card through the optical equipment by way of the wireless controller. Once, the optical equipment receives confirmation of the order from the installer, an equipment order is sent across the communication network to the server. The server performs any verification or security checks needed to complete the order, and then places the order for the desired equipment.

The interactive software program on the server may also be used to gather information from the optical nodes within a given optical network. For instance, the interactive software program on the server may periodically take an inventory of the contents of the optical network in order to determine if the implemented optical network is consistent with the designed (planned) optical network. This may include querying each optical node for a list of its contents. It may also include sending test patterns across the optical network over its connectivity links in order to determine the connectivity of the optical nodes within the optical network.

The interactive software program on the server may periodically gather information concerning the health of the optical network by periodically querying the equipment within each optical node. As one example, the interactive software program on the server may request information that changes over time due to equipment aging or due to changes in the inter-node physical fiber attached to the equipment. Such information may include laser output power, and amplifier gain settings.

Optical nodes may also forward alarms to the interactive software program on the server. Each optical node in the optical network may forward any alarms it may incur to the interactive software program on the server over the communication network. In this manner, the interactive software program on the server may construct a log of events that occur within the optical network. An optical network administrator may be able to observe faults and abnormalities in the optical network by querying the interactive software program on the server for alarm and fault information from a log of events administered by the interactive software program on the server.

In general, status information regarding the optical nodes and overall optical network may be gathered by the server for purposes of reporting to an optical network administrator. The optical network administrator is a person or persons designated to oversee the wellbeing of the optical network. The optical network administrator may periodically query the interactive software program on the server in order to gather statistics or other information concerning the optical network. Additionally, the interactive software program on the server may be queried for information regarding the network topology information and service demands for the plurality of optical nodes.

The interactive software program on the server may also initiate contact with an optical network administrator. This may occur due to equipment failures or fiber cuts (as examples). The interactive software program on the server may contact an optical network administrator using a phone call, a text message, an email, or some other form of communication.

Messages and status information may also be passed between optical nodes via the server. In addition to sending messages over the interconnecting fiber of the optical network, an optical node may use the communication network to pass messages and status information first to the server, and then from the server to another optical node. Lastly, messages and status information may be passed directly between optical nodes via the communication network.

To the users of the interactive software program, the server may also be used as a method of advertising new products and new features via the interactive software program residing on the server. For example, the interactive software program on the server may suggest to the user a new service card for a service the user may be adding to an optical node.

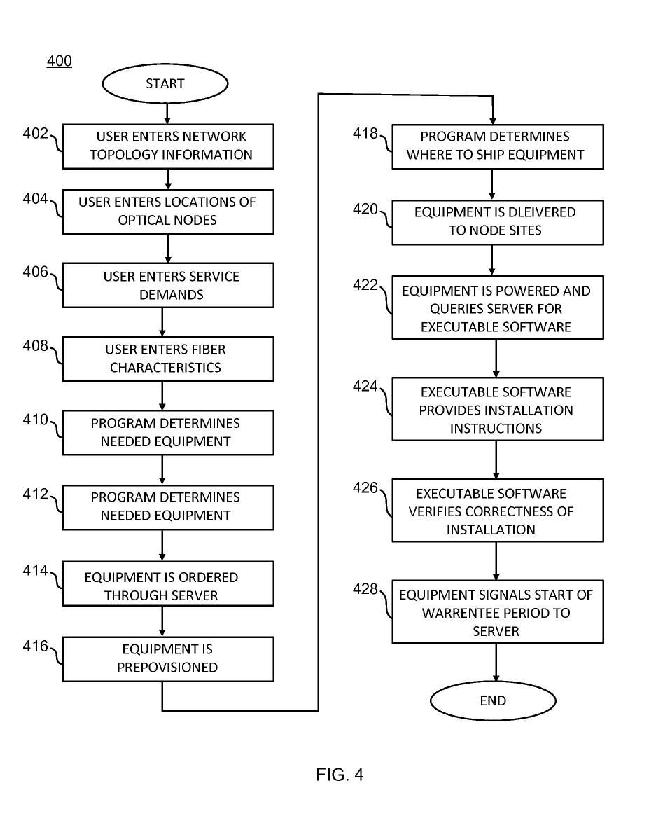

FIG. 4 illustrates the method 400 for designing and constructing an optical network according to the present invention. At block 402, the user enters optical network topology information for a plurality of nodes into the interactive software program residing on the server. Topology information includes identification of optical nodes, and includes the manner in which the nodes are interconnected.

At block 404, the user enters location information for the plurality of nodes into the interactive software program residing on the server. Location information may be in the form of a mailing address, or it may be in the form of GPS coordinates.

At block 406, service demands for the optical nodes are entered into the interactive software program residing on the server. Each service demand may minimally described with the following attributes: a “service type” attribute, a “service rate” attribute, a “service source” attribute, and one or more “service destination” attributes. Service source and destination attributes would typical be described in terms of the optical node locations.

At block 408, the user enters fiber characterization information into the interactive software program. Such information may include: fiber type, fiber chromatic dispersion (CD), fiber polarization mode dispersion (PMD), fiber insertion loss (IL), fiber chromatic dispersion slope, fiber length, and other characteristics.

The user may enter the network topology information, the service demands, the location of the plurality of nodes, and the fiber characterization information into the interactive software program residing on the server using a computer attached to the communication network of which the server is a part. Alternatively, the user may enter the network topology information, the service demands, the location of the plurality of nodes, and the fiber characterization information into the interactive software program residing on the server using a wireless device that can connect to the communication network of which the server is a part.

The optical equipment within the plurality of nodes is connected to the communication network. The server with the interactive software program is also connected to the communication network. Once one or more nodes exist within the optical network, the user of the interactive software program may enter new network topology information, new service demands, the location of the new nodes, and new fiber characterization information into the interactive software program residing on the server using human interfaces residing with the plurality of nodes. The human interfaces may be a touch screen and/or buttons or a key pad that is integrated into the optical equipment within the optical nodes. Information entered by the user into the optical equipment via the touch screen and/or buttons or a key pad is forwarded to the server over the communication network attached to the optical equipment of the nodes. Alternatively, the user may enter the network topology information, the service demands, the location of the plurality of nodes, and the fiber characterization information into the interactive software program residing on the server using a controller that wireless communicates to the optical equipment within the plurality of nodes (as shown in FIG. 1).

The interactive software program residing on the server may be accessed through a web browser. The web browser may be accessed via a computer or wireless device via the communication network. Alternatively, the web browser may be accessed through the optical equipment within an existing optical network.

Continuing with the method outlined in FIG. 4, at block 410, the interactive software program on the server determines the needed optical equipment for the plurality of nodes based upon the information about the optical network entered by the user. For instance, the interactive software program may first determine the number and type of Reconfigurable Optical Add/Drop Multiplexers (ROADMs) needed to configure each node. The interactive software program may then determine the optical amplification needed in each node, based upon the insertion losses of the fiber interconnecting the nodes. Based upon the number and types of service demands at a given node, the interactive software program will determine the number and types of service interface cards required at each node. The interactive software program may provide some choices for the user during each of these portions of the equipment determination phase. Finally, the interactive software program will perform network wide calculations to insure that the requirements of the service demands (e.g., Bit Error Rate) are met. In meeting the requirements of the service demands, alternative equipment may need to be identified and incorporated into the optical network.

At block 414, equipment is ordered. Once the list of optical equipment is generated by the interactive software program, the list of equipment may be ordered through the interactive software program running on the server. For example, there may be a readily available “soft button” located on a graphical screen provided by the interactive software program that, when selected, places an order for the list of optical equipment needed to construct the designed optical network.

At block 416, the optical equipment is pre-provisioned. By provisioning the equipment ahead of time, as equipment is installed into an optical node, the equipment will automatically begin working once service demands are applied to it.

At block 418, the interactive software program determines where to ship the equipment. It does this by noting the physical location of each node, and by knowing which node needs which equipment.

At block 420, the step comprises shipping the optical equipment directly to the locations of the plurality of nodes.

At block 422, the “first piece of equipment to be installed” is powered up, and the equipment queries the server for executable software. The executable software is downloaded to the equipment, and the executable software provides further installation instructions at block 424.

At block 426, the executable software running on the optical equipment verifies the correctness of the installation of the equipment. This step may include involving the interactive software program on the server. The interactive software program on the server may initiate test patterns over the connectivity links throughout the optical network in order to verify the correct installation of the optical equipment from an optical network viewpoint.

Each piece of optical equipment will have an associated warrantee period—with a specific start and end time. At block 428, the step comprises signaling a start of a warrantee period for the optical equipment once the optical equipment is installed.

In the foregoing description, the invention is described with reference to specific example embodiments thereof. It will, however, be evident that various modifications and changes may be made thereto without departing from the broader spirit and scope of the present invention. The specification and drawings are accordingly to be regarded in an illustrative rather than restrictive sense.

What is claimed is:

1. A method for designing and constructing an optical network comprising:
entering optical network topology information for a plurality of nodes into an interactive software program residing on a server;
entering service demands for the nodes into the interactive software program residing on the server; and
ordering optical equipment for the nodes using the interactive software program residing on the server,
wherein the interactive software program determines the optical equipment for the plurality of nodes.

2. The method of claim 1, further comprising entering fiber characterization information into the software program residing on the server.

3. The method of claim 1, further comprising:
entering location information for the plurality of nodes; and
shipping the optical equipment directly to the locations of the plurality of nodes,
wherein the interactive software program automatically determines where to ship the optical equipment based upon the location information.

4. The method of claim 1, further comprising installing the optical equipment within plurality of nodes using instructions residing within the plurality of nodes.

5. The method of claim 4, further comprising verifying the installation of the optical equipment within the plurality of nodes by software running within the plurality of nodes.

6. The method of claim 4, further comprising signaling a start of a warrantee period for the optical equipment once the optical equipment is installed.

7. The method of claim 1, wherein the network topology information and service demands are entered into the interactive software program residing on the server using human interfaces residing within the plurality of nodes.

8. The method of claim 1, wherein the network topology information and service demands are entered into the interactive software program residing on the server using a controller that wirelessly communicates to the plurality of nodes.

9. The method of claim 1, wherein the interactive software program residing on the server is accessed through a web browser.

10. The method of claim 1, further comprising provisioning the optical equipment prior to installing the optical equipment.

11. The method of claim 1, further comprising advertising new products and new features via the interactive software program residing on the server.

12. A system used to design and construct optical networks using optical equipment comprising:
a server;
an interactive software program residing on the server, allowing input of network topology information and service demands for a plurality of optical nodes;
an interactive input device capable of accessing the interactive software program residing on the server; and
a communication network,
wherein the interactive software program determines the optical equipment for the plurality of optical nodes.

13. The system of claim 12, wherein the interactive software program is additionally used to purchase the optical equipment for the plurality of optical nodes.

14. The system of claim 12, wherein the interactive software program determines a shipping destination for the optical equipment based upon node location information entered into the interactive software program.

15. The system of claim 12, further comprising a bootstrapping software program residing in the optical equipment that initiates a download of executable software from the server once the optical equipment is installed within an optical node.

16. The system of claim 12, wherein executable software operating within installed optical equipment within an optical node provides installation instructions for additional equipment within the optical node.

17. The system of claim 12, wherein the server initiates a download of executable software to the optical equipment installed within an optical node.

18. The system of claim 12, wherein the interactive input device resides within the optical equipment installed within an optical node.

19. The system of claim 12, wherein the interactive input device is a controller that wirelessly communicates to the optical equipment installed within an optical node.

20. The system of claim 12, wherein the interactive software program on the server may be queried for information regarding network topology information and service demands for the plurality of optical nodes.

21. The system of claim 12, wherein status information regarding the optical nodes may be gathered by the server for purposes of reporting to a network administrator.

22. The system of claim 12, wherein messages and status information may be passed between optical nodes via the server.
